(19) United States
(12) Patent Application Publication
(10) Pub. No.: US 2024/0276908 A1
(43) Pub. Date: Aug. 22, 2024

(54) MOWING MACHINE

(71) Applicant: TOYOTA JIDOSHA KABUSHIKI KAISHA, Toyota-shi (JP)

(72) Inventor: Shinsuke SATO, Toyota-shi (JP)

(73) Assignee: TOYOTA JIDOSHA KABUSHIKI KAISHA, Toyota-shi (JP)

(21) Appl. No.: 18/408,233

(22) Filed: Jan. 9, 2024

(30) Foreign Application Priority Data
Feb. 16, 2023 (JP) 2023-022927

(51) Int. Cl. A01D 34/00; A01D 101/00

(52) U.S. Cl. CPC A01D 34/008; A01D 2101/00

(57) ABSTRACT

A mowing machine, including: a memory; a processor coupled to the memory; and a mowing machine main body including a drive motor configured to drive a movement mechanism and a cutting blade motor configured to drive a cutting blade configured to cut grass, wherein the processor is configured to: acquire information related to a state of grass growth in a mowing target region, predict a load that will be applied to the cutting blade motor at a time of cutting the grass based on the acquired information related to the state of grass growth, set a travel path based on the predicted load, and control driving of the drive motor such that the mowing machine main body travels along the set travel path.

### CROSS-REFERENCE TO RELATED APPLICATION

This application claims priority under 35 USC 119 from Japanese Patent Application No. 2023-022927, filed on Feb. 16, 2023, the disclosure of which is incorporated by reference herein.

### BACKGROUND

### Technical Field

The present disclosure relates to a mowing machine.

### Related Art

International Publication (WO) No. 2017/154524 discloses a self-propelled mowing machine that reduces the burden on a cutting blade motor by mowing in a meandering manner, and it is described that when the load on the cutting blade motor rises, the method is switched to a method in which mowing is performed while meandering.

In a self-propelled mowing machine, continuously meandering driving lowers the efficiency of mowing. As with the mowing machine described in WO No. 2017/154524, in a case of switching between driving modes in accordance with the load on the cutting blade motor, since a switch is made to the meandering mode after the load on the cutting blade motor has increased, there are cases in which the cutting blade motor is overloaded.

### SUMMARY

The present disclosure provides a mowing machine that may suppress overload on a cutting blade motor.

A first aspect of the present disclosure is a mowing machine including: a memory; a processor coupled to the memory; and a mowing machine main body including a drive motor configured to drive a movement mechanism and a cutting blade motor configured to drive a cutting blade configured to cut grass, wherein the processor is configured to: acquire information related to a state of grass growth in a mowing target region, predict a load that will be applied to the cutting blade motor at a time of cutting the grass based on the acquired information related to the state of grass growth, set a travel path based on the predicted load, and control driving of the drive motor such that the mowing machine main body travels along the set travel path.

In the mowing machine of the first aspect of the present disclosure, information relating to the state of grass growth in a mowing target region is acquired, the load that will be applied to the cutting blade motor when mowing is predicted based on the acquired information, and a travel path is set based on the predicted load. This may enable overloading of the cutting blade motor to be suppressed by setting a travel path that does not cause overloading of the load applied to the cutting blade motor with advance consideration of the load that will applied to the cutting blade motor.

In a second aspect of the present disclosure, in the first aspect, the processor may be further configured to set the travel path such that an accumulated value of the load does not exceed a predetermined threshold value.

In the mowing machine of the second aspect of the present disclosure, since the path setting unit sets the travel path such that an accumulated value of the load does not exceed a predetermined threshold value, fatigue fracture of the cutting blade motor may be suppressed.

In a third aspect of the present disclosure, in the first aspect, the processor may be further configured to set the travel path such that a maximum value of the load does not exceed a predetermined threshold value.

In the mowing machine of the third aspect of the present disclosure, since the path setting unit sets the travel path such that a maximum value of the load does not exceed a predetermined threshold value, damage to the cutting blade motor may be suppressed.

In a fourth aspect of the present disclosure, in the first aspect, the processor may be further configured to set an initial travel path relative to the mowing target region, and to set the travel path by correcting the initial travel path based on the predicted load.

In the mowing machine of the fourth aspect of the present disclosure, the path setting unit sets an initial travel path relative to the mowing target region, and corrects the initial travel path based on the load predicted by the load prediction unit. Since this enables the initial travel path to be corrected such that the load applied to the cutting blade motor is not overloaded in the fourth aspect, overloading of the cutting blade motor may be suppressed.

According to the above-described aspects, the mowing machine of the present disclosure may suppress overloading of the cutting blade motor.

### BRIEF DESCRIPTION OF THE DRAWINGS

Exemplary embodiments will be described in detail based on the following figures, wherein:

FIG. 1 is a perspective view schematically illustrating a configuration of a mowing machine according to a first exemplary embodiment of the present disclosure;

FIG. 2 is a side cross-sectional view illustrating a mowing machine according to a first exemplary embodiment of the present disclosure in a state in which the mowing machine is partially broken away as seen from the side;

FIG. 3 is a block diagram illustrating a hardware configuration of a mowing machine according to a first exemplary embodiment of the present disclosure;

FIG. 4 is a diagram illustrating a functional configuration of a mowing machine according to a first exemplary embodiment of the present disclosure;

FIG. 5 is a flow chart illustrating a series of processing performed by a mowing machine according to a first exemplary embodiment of the present disclosure; and

FIG. 6 is a flow chart illustrating a series of processing performed by a mowing machine according to a second exemplary embodiment of the present disclosure.

### DETAILED DESCRIPTION

### First Exemplary Embodiment

Explanation follows regarding a mowing machine 10 according to a first exemplary embodiment of the present disclosure, with reference to the drawings. Note that the arrows UP, FR, and RH in the drawings respectively indicate upward in the vertical direction, forward in the front-rear direction, and rightward in the left-right direction of the mowing machine 10. Since the mowing machine 10 is configured to be movable in both forward and rearward directions, the forward direction and the travel direction do not necessarily coincide with each other.

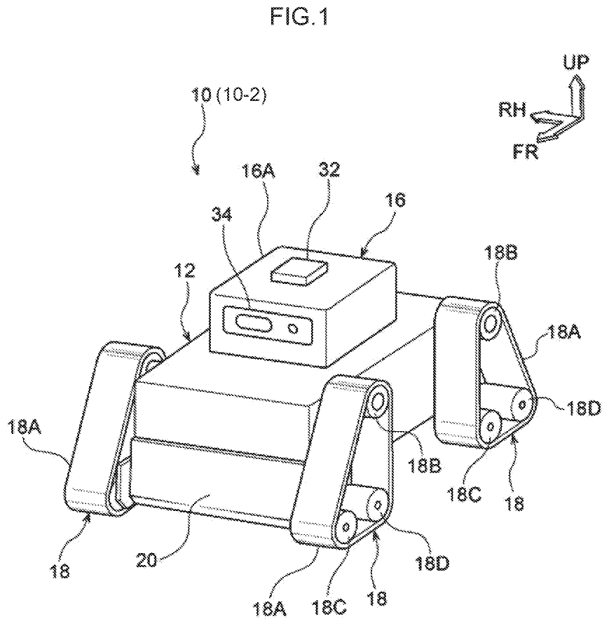

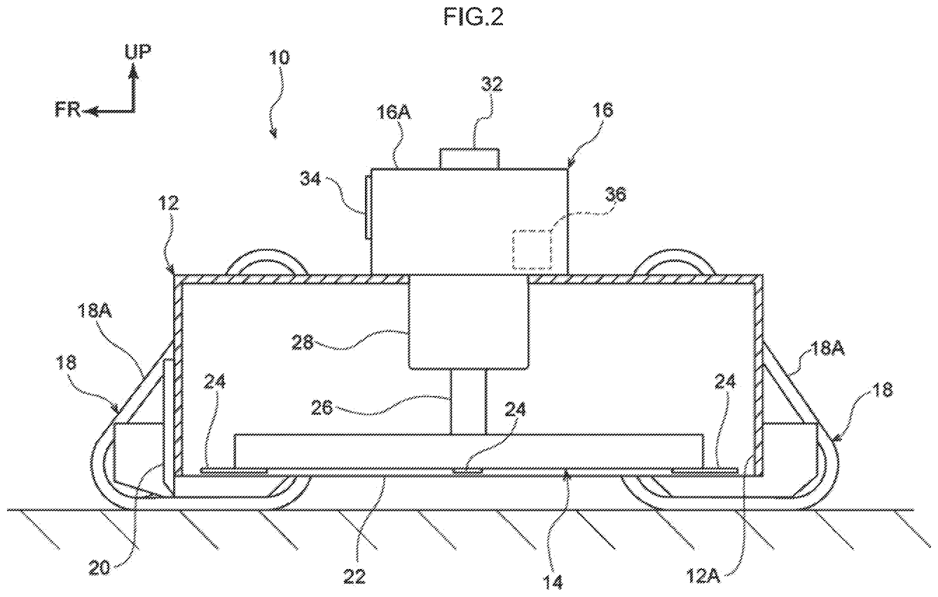

As illustrated in FIG. 1 and FIG. 2, the mowing machine 10 of the present exemplary embodiment is mainly configured including a mowing machine main body 12, a cutting blade unit 14, and a control unit 16.

### [Mowing Machine Main Body 12]

The mowing machine main body 12 is formed in a substantially rectangular parallelepiped shape with an open lower side, and a crawler unit 18 is provided at the mowing machine main body 12 as a movement mechanism. The crawler unit 18 is provided on both left and right sides at a front end part and on both left and right sides at a rear end part of the mowing machine main body 12.

Each crawler unit 18 is configured including a rubber crawler 18A, a drive wheel 18B, a first idler wheel 18C, and a second idler wheel 18D. The rubber crawler 18A is formed in an endless band shape, and is wrapped around the drive wheel 18B, the first idler wheel 18C, and the second idler wheel 18D.

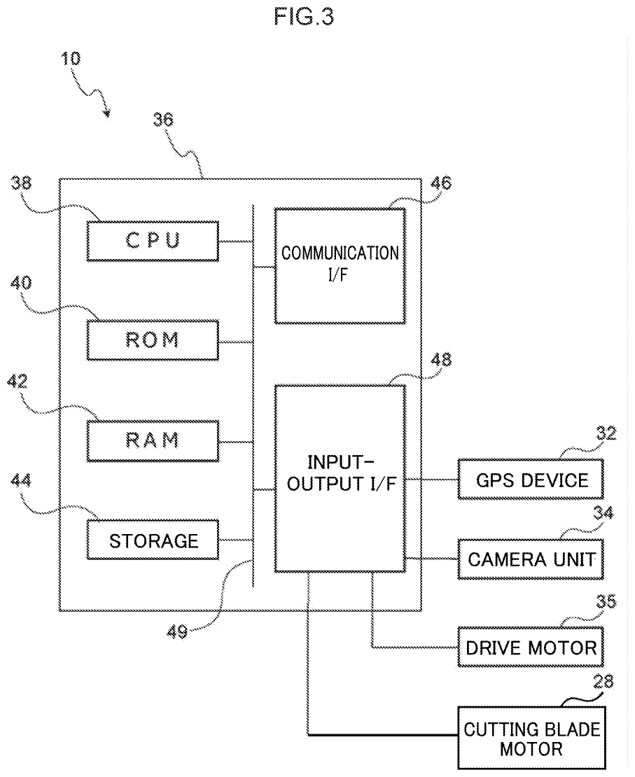

The drive wheel 18B is connected to a drive motor 35 (see FIG. 3) disposed inside the mowing machine main body 12 via a non-illustrated rotary shaft. The drive motor 35 is configured to be supplied with power from a non-illustrated battery, and by supplying power and actuating the drive motor 35, the drive wheel 18B rotates and the rubber crawler 18A moves so as to circulate in one direction.

The first idler wheel 18C is disposed forward and downward with respect to the drive wheel 18B, and is rotatably attached to a non-illustrated rotation shaft extending in a left-right direction. The first idler wheel 18C rotates following the movement of the rubber crawler 18A. The second idler wheel 18D is disposed rearward of the first idler wheel 18C, and is rotatably attached to a non-illustrated rotation shaft extending in a left-right direction. The second idler wheel 18D rotates following the movement of the rubber crawler 18A.

The drive motor 35 is provided independently for each of the four crawler units 18, and by controlling the four drive motors 35, the mowing machine 10 can be made to move in a given direction. Note that FIG. 3 collectively illustrates the four drive motors 35 for simplicity of explanation.

A cover 20 is provided at a front surface of the mowing machine main body 12. The cover 20 is a substantially flat plate-shaped member having a plate thickness direction in a front-rear direction, and extends in the vertical direction and in the left-right direction. The lower end of the cover 20 is located below the lower end of the mowing machine main body 12, and the gap between the mowing machine main body 12 and the ground is narrowed by the cover 20. The cover 20 prevents foreign matter such as stones from entering the cutting blade unit 14, which is described below.

Note that although in the present exemplary embodiment, as an example, the cover 20 is provided only on a front surface of the mowing machine main body 12, there is no limitation thereto. For example, a similar cover 20 may be provided on a rear surface and at side surfaces of the mowing machine main body 12. Similarly to the cover 20, members for preventing foreign matter from entering may be provided on both sides of the mowing machine main body 12.

### [Cutting Blade Unit 14]

As illustrated in FIG. 2, a cutting blade unit 14 is provided inside the mowing machine main body 12. The cutting blade unit 14 is configured including a rotary member 22, a cutting blade 24, a rotary shaft 26, and a cutting blade motor 28.

The rotating member 22 is disposed in the vicinity of the lower opening 12A of the mowing machine main body 12, with the vertical direction serving as its plate thickness direction. The rotary member 22 is fixed to a rotary shaft 26, described below, and is configured so as to be rotatable with respect to the mowing machine main body 12 together with the rotary shaft 26.

The rotary member 22 is provided with plural cutting blades 24. The cutting blade 24 is attached to an outer peripheral end part of the rotary member 22, and in the present exemplary embodiment, as an example, four cutting blades 24 are provided at regular intervals along the circumferential direction of the rotary member 22.

The cutting blades 24 are each formed of a thin metal member with a plate thickness direction in a vertical direction, and are configured so as to be capable of mowing.

The rotary shaft 26 is disposed at a central part of the mowing machine main body 12 and extends in a vertical direction, and the rotary member 22 is attached to a lower end part of the rotary shaft 26. An upper end part of the rotary shaft 26 is connected to the cutting blade motor 28.

The cutting blade motor 28 is attached to an upper part of the mowing machine main body 12, and is driven by power supplied from a non-illustrated battery provided in the mowing machine main body 12. The cutting blade motor 28 includes a non-illustrated output shaft, and the output shaft and the rotary shaft 26 are connected together via a non-illustrated gear, pulley, or the like. Accordingly, when the cutting blade motor 28 is driven, rotational force is transmitted to the rotary member 22 through the rotating shaft 26, and the rotary member 22 rotates in one direction centered on the rotating shaft 26.

As illustrated in FIG. 1 and FIG. 2, the control unit 16 is provided on the upper surface of the mowing machine main body 12, and includes a substantially rectangular parallelepiped-shaped case 16A.

A global positioning system (GPS) device 32 is attached to an upper surface of the case 16A. The GPS device 32 is a device that measures the current position of the mowing machine 10, and is configured including a non-illustrated antenna that receives signals from a GPS satellite.

A camera unit 34 is attached to a front surface of the case 16A as an image capture device. The camera unit 34 is a unit configured by combining plural cameras, and is capable of capturing peripheral conditions including a travel direction of the mowing machine 10. The control unit 16 is provided with a controller 36.

### [Hardware Configuration of the Mowing Machine 10]

FIG. 3 is a block diagram illustrating a hardware configuration of the mowing machine 10. As illustrated in FIG. 3, the controller 36 configuring the mowing machine 10 is configured including a central processing unit (CPU: processor) 38, read only memory (ROM) 40, random access memory (RAM) 42, a storage 44, a communication interface (I/F) 46, and an input/output interface (I/F) 48. These configurations are connected together via a bus 49 so as to be capable of communicating with each other.

The CPU 38 is a central processing unit that executes various programs and controls various parts. Namely, the CPU 38 reads a program from the ROM 40 or the storage 44, and executes the program using the RAM 42 as a workspace. The CPU 38 controls the respective configurations and performs various computation processing in accordance with a program recorded in the ROM 40 or the storage 44.

The ROM 40 stores various programs and various data. The RAM 42 is a non-transitory recording medium that serves as a workspace to temporarily store programs and data. The storage 44 is configured by a hard disk drive (HDD) or a solid state drive (SSD), and is a non-transitory recording medium that stores various programs including an operating system, as well as various data. In the present exemplary embodiment, an autonomous driving program, various data, and the like for the mowing machine 10 are stored in the storage 44.

The communication I/F 46 is an interface for the mowing machine 10 to communicate with other devices, and for example, employs a protocol such as a controller area network (CAN), Ethernet (registered trademark), long term evolution (LTE), fiber distributed data interface (FDDI), or Wi-Fi (registered trademark).

The input/output I/F 48 is electrically connected to the GPS device 32, the camera unit 34, the drive motor 35, and the cutting blade motor 28. The controller 36 controls the drive motor 35 based on an image of surroundings detected by the camera unit 34 and information such as the current position of the mowing machine 10 acquired by the GPS device 32, thereby autonomously driving the mowing machine 10.

### [Functional Configuration of the Mowing Machine 10]

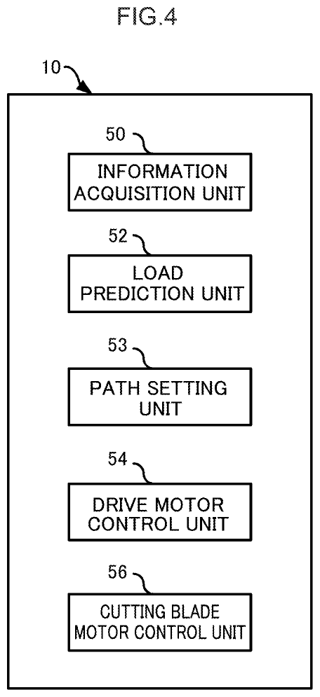

The mowing machine 10 implements various functions using the above-described hardware resources. Explanation follows regarding functional configuration implemented by the mowing machine 10, with reference to FIG. 4.

As illustrated in FIG. 4, the functional configuration of the mowing machine 10 includes an information acquisition unit 50, a load prediction unit 52, a path setting unit 53, a drive motor control unit 54, and a cutting blade motor control unit 56. Note that the respective functional configuration is implemented by the CPU 38 reading and executing a program stored in the ROM 40 or the storage 44.

The information acquisition unit 50 acquires image information on the travel direction of the mowing machine 10 captured by the camera unit 34, and acquires information such as the current position of the mowing machine 10 acquired by the GPS device 32. Moreover, the information acquisition unit 50 acquires information relating to the growth state of grass in the mowing target region in which mowing is to be performed.

Explanation follows regarding a method of acquiring information relating to the growth state of grass. As an example of an acquisition method, for example, data is acquired based on actual measurement in advance of how much the height of the grass increases within a predetermined period for each type of grass living in a mowing target region that is the target of mowing. Then, the mowing target region is segmented into plural regions, and the degree of exposure to sunlight of the segmented region is set for each segmented region. Note that as an example, the degree of exposure to sunlight is set according to the direction (south facing, north facing, or the like) that the segmented region faces. Note that the value of the degree of exposure to sunlight increases, the more south facing the direction is.

Then, based on the above data and the degree of exposure to sunlight, an equation indicating the state of growth of the grass is generated, and the state of growth of the grass is derived based on the equation. Note that Equation (1) below, for example, can be used as the equation.

$$P = H ( mm / t ) \times T ( t ) \times K \qquad ( 1 )$$

In the above Equation (1), P denotes an index representing the state of grass growth, H denotes the amount of plant height increase per unit time, T denotes time, and K denotes a weighting factor according to the degree of exposure to sunlight. Note that, the weighting factor corresponding to the degree of exposure to sunlight increases as the degree of exposure to sunlight increases.

Note that methods for acquiring information relating to the state of grass growth are not limited to the above. For example, an aerial image of a mowing target area captured by flying a drone equipped with a camera in advance may be acquired, and the grass may be detected from the image information of the aerial image, and the height of the grass may be calculated by image processing.

Specifically, an aerial image is analyzed, and orthoimage data, which is data for a three-dimensional image that accurately displays the position and size of a subject, and RGB image data, which is data for a color image including color information, are acquired. Note that, the coordinate position information in the RGB image data and orthoimage data converted from the RGB image data are associated with each other. Then, using a well-known method, the location where the grass is growing is detected from the RGB image data, and the height of the grass at the detected location is detected in the orthoimage data.

Alternatively, artificial intelligence (AI) technology may be used as a method of acquiring information relating to the state of grass growth. More specifically, using a learned model that was machine-learned in advance using environmental information such as image information, sunshine time, temperature, and the like of a mowing target region, and learning information including the height of the grass in the mowing target region, the state of grass cultivation may be derived.

Further, a technique employing a multi-spectrum camera may be used as a method of acquiring information relating to the state of grass growth. This is a well-known technology that enables the growth state of plants to be ascertained from observation of sunlight, illumination light, or returning light from light thereof that is incident on plants, trees, and the like. For example, since the color of light is different between grass with a good growth state and grass with a poor growth state, the growth state of the grass can be ascertained.

The load prediction unit 52 predicts the load applied to the cutting blade motor 28 when the grass is cut based on the information relating to the growth state of the grass acquired by the information acquisition unit 50. More specifically, the load prediction unit 52 derives and stores a table in which the relationship between the grass height and the output value of the drive motor 35 is set in advance. The load prediction unit 52 refers to the table described above, and acquires the output of the drive motor 35 corresponding to the height of the grass as the load that will be applied to the cutting blade motor 28 when the grass of the relevant height is cut.

The path setting unit 53 sets a travel path based on the load predicted by the load prediction unit 52, and stores this in the storage 44, as an example. As an example, the path setting unit 53 of the present exemplary embodiment sets the travel path such that the accumulated value of the load does not exceed a predetermined threshold A1 and such that the maximum value of the load does not exceed a predetermined threshold A2. Note that the predetermined threshold A1 is set to a value that is smaller than the above-described cumulative value of a load when the cutting blade motor 28 has experienced fatigue failure when grass has actually been cut by the cutting blade 24. Moreover, the predetermined threshold A2 is set to a value that is smaller than the above-described value of the load when the cutting blade motor 28 has been damaged when grass has actually been cut by the cutting blade 24.

The drive motor control unit 54 controls the output of the drive motor 35 disposed inside the mowing machine main body 12. More specifically, the drive motor control unit 54 refers to the travel path stored in the storage 44, map data, the captured image captured by the camera unit 34, and the current position of the mowing machine 10 acquired by the GPS device 32, and controls the drive motor 35 so as to cause the mowing machine 10 to travel along the travel path. Note that in a case in which an object approaching the mowing machine 10 is detected in the captured image captured by the camera unit 34, the drive motor control unit 54 controls the drive motor 35 so as to enable the mowing machine 10 to be temporarily stopped.

When driving of the mowing machine 10 is started by the drive motor control unit 54, the cutting blade motor control unit 56, based on a preset rotation frequency, rotational velocity, rotational direction, and the like of the cutting blade motor 28, drive controls the rotation frequency, rotational velocity, rotational direction, and the like, of the cutting blade motor 28. Moreover, it is possible for the cutting motor control unit 56, in cases in which an object approaching the mowing machine 10 is detected in a captured image captured by the camera unit 34 or in cases in which overload has been applied to the cutting blade motor 28, to control the cutting blade motor 28 and temporarily stop the rotation of the cutting blade 24.

### Mechanism of First Exemplary Embodiment

Next, explanation follows regarding the mechanism of the first exemplary embodiment.

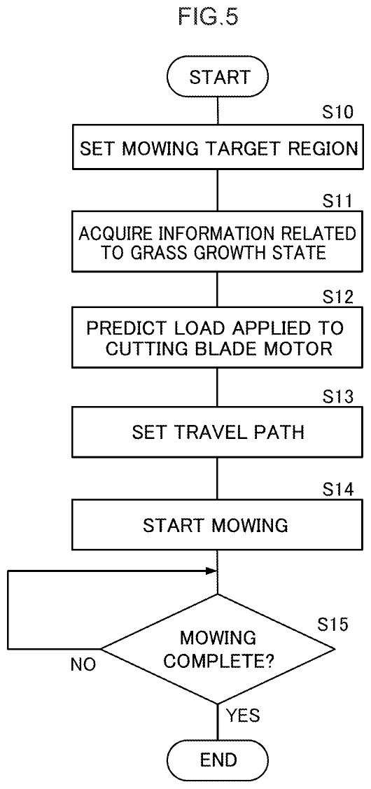

FIG. 5 is a flowchart illustrating an example of a series of processing performed by the mowing machine 10. A series of processing performed by the mowing machine 10 is executed by the CPU 38 reading a program from the ROM 40 or the storage 44 and expanding the program in the RAM 42.

As illustrated in FIG. 5, at step S10, the CPU 38 sets a mowing target region as a target for mowing by the mowing machine 10. More specifically, information indicating the mowing target region is input by an input means (not illustrated) via the input/output I/F 48 and stored in the storage 44.

Next, at step S11, the CPU 38 acquires information relating to the state of grass growth. More specifically, the CPU 38 uses the functionality of the information acquisition unit 50 to acquire information relating to the state of grass growth using the foregoing equation (1), as described above. Note that, as an example, the time elapsed from the date and time when mowing was previously performed in the mowing target region, which is stored in the storage 44, is input via the input/output I/F 48 by an input means (not illustrated).

Next, at step S12, the CPU 38 predicts the load that will be applied to the cutting blade motor 28. More specifically, as described above, the CPU 38 uses the functionality of the load prediction unit 52 to predict the load that will be applied to the cutting blade motor 28, when the grass is cut based on the information relating to the growth state of the grass acquired by the information acquisition unit 50.

Next, the CPU 38 sets a travel path at step S13. More specifically, as described above, the CPU 38 uses the functionality of the path setting unit 53 to set the travel path such that the accumulated value of the load predicted by the load prediction unit 52 does not exceed the predetermined threshold A1 and such that the maximum value of the load does not exceed the predetermined threshold A2. At this time, regarding places that have deviated from the travel path set by the path setting unit 53, even though grass has grown, on the assumption that the predetermined threshold A1 or the predetermined threshold A2 has been exceeded, data indicating the relevant location is output through the communication I/F 46, for example. Accordingly, based on the output data, the grass at the relevant location is cut in advance or manually after the mowing by the mowing machine 10 has been completed.

Next, at step S14, the CPU 38 causes the mowing machine 10 to start mowing the mowing target region. More specifically, the CPU 38 uses the functionality of the drive motor control unit 54 to control the drive motor 35 so as to cause the mowing machine 10 to travel along the travel path, as described above.

Next, at step S15, the CPU 38 determines whether or not the mowing of the mowing target region by the mowing machine 10 has been completed. More specifically, it is determined whether or not mowing has been completed by determining whether or not travel of the mowing machine 10 on the travel path set by the path setting unit 53 has been completed. In cases in which the mowing has not been completed (step S15: NO), the CPU 38 continues to cause the mowing machine 10 to perform mowing until the mowing has been completed. Further, in cases in which mowing has been completed (step S15: YES), the CPU 38 ends the series of processing.

As described above, in the mowing machine 10 of the first exemplary embodiment, by using the crawler unit 18, as a movement mechanism, to rotate the cutting blade 24 while moving the mowing machine main body 12, grass in the surroundings of the mowing machine main body 12 can be cut.

Further, in the first exemplary embodiment, the mowing machine 10 acquires information relating to the state of grass growth in the mowing target area, based on the acquired information, predicts the load that will be applied to the cutting blade motor 28 when cutting the grass, and sets a travel path based on the predicted load. Accordingly, by setting a travel path that prevents the load applied to the cutting blade motor 28 from becoming overloaded by advance consideration of the load that will be applied to the cutting blade motor 28, overloading of the cutting blade motor 28 may be suppressed.

Further, in the first exemplary embodiment, since the path setting unit 53 of the mowing machine 10 sets the travel path such that the accumulated load applied to the cutting blade motor 28 will not exceed the predetermined threshold A1, fatigue fracture of the cutting blade motor 28 may be suppressed.

Further, in the first exemplary embodiment, since the path setting unit 53 of the mowing machine 10 sets the travel path such that the maximum value of the load applied to the cutting blade motor 28 will not exceed the predetermined threshold A2, damage to the cutting blade motor 28 may be suppressed.

### Second Exemplary Embodiment

Next, explanation follows regarding a mowing machine 10-2 (see FIG. 1) according to a second exemplary embodiment of the present disclosure. Note that since the mowing machine 10-2 of the second exemplary embodiment has substantially the same configuration as the mowing machine 10 of the first exemplary embodiment, explanation of similar features is omitted, and explanation is given only of different features.

The path setting unit 53 of the mowing machine 10 of the first exemplary embodiment described above, sets the travel path such that the accumulated value of the load predicted in advance by the load prediction unit 52 does not exceed the predetermined threshold A1, and such that the maximum value of the load does not exceed the predetermined threshold A2. However, the path setting unit 53 of the mowing machine 10-2 of the second exemplary embodiment sets an initial path relative to the mowing target region in advance. The path setting unit 53 then re-sets the travel path by correcting the initial travel path based on the load that will be applied to the cutting blade motor 28 predicted by the load prediction unit 52.

More specifically, the path setting unit 53 corrects the initial travel path such that the accumulated value of the load predicted by the load prediction unit 52 does not exceed the predetermined threshold A1 and such that the maximum value of the load does not exceed the predetermined threshold A2.

### Mechanism of Second Exemplary Embodiment

Next, explanation follows regarding the mechanism of the second exemplary embodiment.

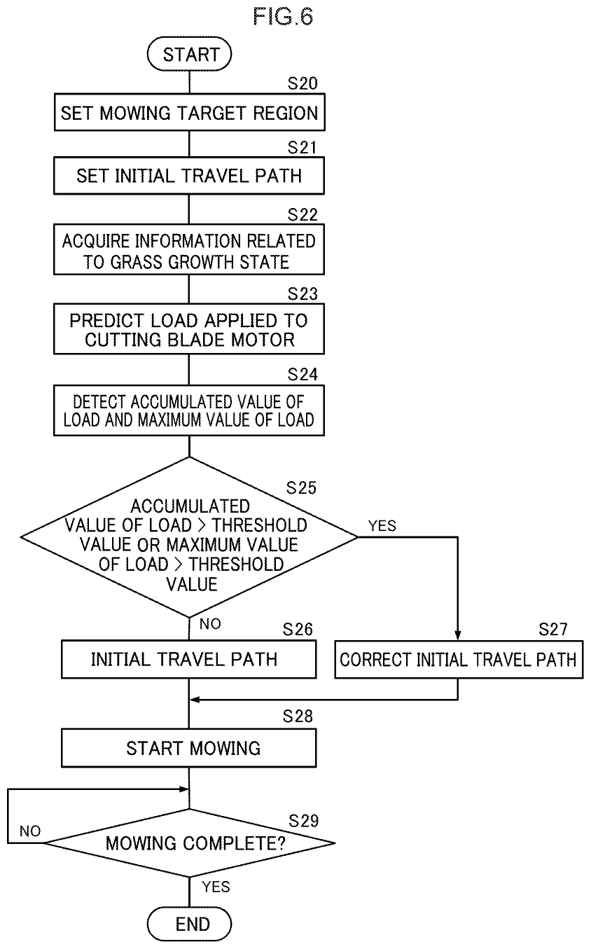

FIG. 6 is a flowchart illustrating an example of a series of processing performed by the mowing machine 10-2. A series of processing performed by the mowing machine 10-2 is executed by the CPU 38 reading a program from the ROM 40 or the storage 44 and expanding the program in the RAM 42.

As illustrated in FIG. 6, at step S20, the CPU 38 sets a mowing target region as a target for mowing by the mowing machine 10. More specifically, information indicating the mowing target region is input by an input means (not illustrated) via the input/output I/F 48 and stored in the storage 44.

Next, at step S21, the CPU 38 sets an initial travel path for the mowing target region. More specifically, the CPU 38 uses the functionality of the path setting unit 53 to set an initial travel path so as to travel through the entire area of the mowing target region.

Next, the CPU 38 acquires information relating to the state of grass growth at step S22 in the same manner as in the first exemplary embodiment described above, and at step S23 predicts the load that will be applied to the cutting blade motor 28.

Next, at step S24, based on the predicted load that will be applied to the cutting blade motor 28, the CPU 38 detects the accumulated value of the load that will be applied to the cutting blade motor 28 during travel along the set travel path and the maximum value of the load that will be applied to the cutting blade motor 28 during travel along the set travel path.

Next, the CPU 38 determines at step S25 whether or not the cumulative value of the load that will be applied to the cutting blade motor 28 during travel along the set travel path set will exceed the predetermined threshold A1, or whether or not the maximum value of the load that will be applied to the cutting blade motor 28 during travel along the set travel path will exceed the predetermined threshold A2. In cases in which the determination at step 25 is negative (step S25: NO), at step S26, the CPU 38 uses the functionality of the path setting unit 53 to set the initial travel path as the travel path.

On the other hand, in a case in which the determination at step S25 is affirmative (step S25: YES), the CPU 38 corrects the initial travel path at step S27. More specifically, the CPU 38 resets the travel path by correcting the initial travel path using the functionality of the path setting unit 53 such that the accumulated value of the load predicted by the load prediction unit 52 will not exceed the predetermined threshold A1, and such that the maximum value of the load will not exceed the predetermined threshold A2.

Next, at step S28, the CPU 38 causes the mowing machine 10-2 to start mowing the mowing target region. Next, at step S29, the CPU 38 determines whether or not the mowing of the mowing target region by the mowing machine 10-2 has been completed, and in cases in which the mowing has not been completed (step S29: NO), the CPU 38 continues to cause the mowing machine 10-2 to perform mowing until the mowing has been completed. On the other hand, in cases in which mowing has been completed (step S29: YES), the CPU 38 ends the series of processing.

As described above, in the mowing machine 10-2 of the second exemplary embodiment, the path setting unit 53 sets an initial travel path for the mowing target region, and corrects the initial travel path based on the load predicted by the load prediction unit 52. This enables the initial travel path to be corrected such that the load applied to the cutting blade motor 28 will not be overloaded, whereby overloading of the cutting blade motor 28 may be suppressed.

Although explanation has been given regarding the mowing machines 10, 10-2 according to the exemplary embodiments described above, it will be apparent that various embodiments may be implemented within a range not departing from the gist of the present disclosure. In the exemplary embodiments described above, the load that will be applied to the cutting blade motor 28 is predicted based solely on the height of the grass; however, the present disclosure is not limited to this. For example, the diameter of a grass stem may be estimated, and the load applied to the cutting blade motor 28 may be predicted in consideration of the estimated stem diameter.

More specifically, there is a method in which a stem diameter estimation unit is added to the functional configuration of the mowing machines 10, 10-2. The stem diameter estimation unit identifies the type of grass detected on the planned travel route along which the mowing machine main body 12 will travel, based on the image information acquired by the information acquisition unit 50. For example, the grass type is identified by referring to a pre-stored database of grass and comparing this with image information. The stem diameter estimation unit then estimates the stem diameter from the identified grass type. At this time, the stem diameter estimation unit may estimate the stem diameter in consideration of the plant height calculated by the information acquisition unit 50.

In the exemplary embodiments described above, although the path setting unit 53 sets the travel path such that the accumulated value of the load predicted by the load prediction unit 52 will not exceed the predetermined threshold A1 and such that the maximum value of the load will not exceed the predetermined threshold A2, the present disclosure is not limited to this. For example, the path setting unit 53 may set the travel path such that the accumulated value of the load predicted by the load prediction unit 52 does not exceed a predetermined threshold A1, or may set the travel path such that the maximum value of the load predicted by the load prediction unit 52 does not exceed the predetermined threshold A2.

Although the GPS device 32 is used as a satellite positioning system in the exemplary embodiment described above, the present disclosure is not limited to this. For example, known technology such as the Global Navigation Satellite System (GNSS) or the Quasi-Zenith Satellite System (QZSS) can be used.

Although the crawler unit 18 of the exemplary embodiments described above is configured by a rubber crawler 18A configured by a pillar having a substantially right-angled triangular shape, the present disclosure is not limited to this. For example, the shape may be an elliptical shape, or may be a circular shape, or may be modified as appropriate.

Although the mowing machines 10, 10-2 are four-wheel drive in the exemplary embodiments described above, the present disclosure is not limited to this, and the mowing machines may be two-wheel drive.

Although the crawler unit 18 is employed as the drive unit in the exemplary embodiments described above, the present disclosure is not limited to this. The drive unit may be, for example, a wheel. The number of drive units of the mowing machine of the present disclosure is not limited to four, and may be a structure including one drive unit on each of the left side and the right side.

Moreover, the processing executed by the CPU 38 reading and executing a program in the exemplary embodiments described above may be executed by various types of processor other than the CPU 38. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Further, the above-described processing may be executed by any one of these various types of processor, or by a combination of two or more of the same type or different types of processor, and may be executed by plural FPGAs, or by a combination of a CPU and an FPGA, for example. The hardware structure of these various types of processors is more specifically an electric circuit combining circuit elements such as semiconductor elements.

Although the various data is stored in the storage 44 in the exemplary embodiments described above, there is no limitation thereto. For example, a non-transitory recording medium such as a compact disc (CD), a digital versatile disc (DVD), or universal serial bus (USB) memory may act as a storage part. In such cases, various programs, data, and the like are stored in these recording media.

Moreover, the flow of processing described in the exemplary embodiment described above is an example, and unnecessary steps may be deleted, new steps may be added, or the processing order may be rearranged within a range not departing from the spirit of the present invention.

What is claimed is:

1. A mowing machine, comprising:
a memory;
a processor coupled to the memory; and
a mowing machine main body including a drive motor configured to drive a movement mechanism and a cutting blade motor configured to drive a cutting blade configured to cut grass,
wherein the processor is configured to:
acquire information related to a state of grass growth in a mowing target region,
predict a load that will be applied to the cutting blade motor at a time of cutting the grass based on the acquired information related to the state of grass growth,
set a travel path based on the predicted load, and
control driving of the drive motor such that the mowing machine main body travels along the set travel path.

2. The mowing machine of claim 1, wherein the processor is further configured to set the travel path such that an accumulated value of the load does not exceed a predetermined threshold value.

3. The mowing machine of claim 1, wherein the processor is further configured to set the travel path such that a maximum value of the load does not exceed a predetermined threshold value.

4. The mowing machine of claim 1, wherein the processor is further configured to set an initial travel path relative to the mowing target region, and to set the travel path by correcting the initial travel path based on the predicted load.
